(19) United States
(12) Patent Application Publication
(10) Pub. No.: US 2014/0302222 A1
(43) Pub. Date: Oct. 9, 2014

(54) METHOD FOR PROCESSING CACAO COMPOSITION USING ALKALINE ELECTROLYTIC WATER

(71) Applicant: Young-Il Aa, Gyeonggi-do (KR)

(72) Inventor: Young-Il Aa, Gyeonggi-do (KR)

(21) Appl. No.: 14/356,664

(22) PCT Filed: Mar. 27, 2013
(86) PCT No.: PCT/KR2013/002541

§ 371 Date: May 7, 2014

(30) Foreign Application Priority Data
Apr. 10, 2012 (KR) 10-2012-0037440

(51) Int. Cl. A23G 1/02; A23G 1/30

(52) U.S. Cl. CPC A23G 1/02; A23G 1/30
USPC 426/631; 426/507; 426/466

(57) ABSTRACT

The present invention relates to a method for processing a cacao composition using alkaline electrolytic water. More particularly, the present invention relates to a method for processing a cacao composition using alkaline electrolytic water that is characterized in that a cacao composition, which has an excellent flavor, aroma, and color and which is harmless to the human body can be processed using alkaline electrolytic water prepared through an electrolysis method, which is different from conventional methods using a chemical compound, and the present invention can reduce manufacturing costs by readily regulating the pH of alkaline electrolytic water to thereby increase the efficiency of process control.

### CROSS-REFERENCE TO RELATED PATENT APPLICATION

This application claims the benefit of Korean Patent Application No. 10-2012-0037440, filed on Apr. 10, 2012, in the Korean Intellectual Property Office, the disclosure of which is incorporated herein by reference in its entirety.

### FIELD

The present invention relates to a method of treating a cacao material using alkaline electrolyzed water. More particularly, the present invention relates to a method of treating a cacao material not using a conventional chemical agent but using alkaline electrolyzed water to obtain a cacao product with high quality flavor, fragrance and color.

### BACKGROUND

The chocolate or cocoa is made of a cacao material from a cacao fruit of a cacao tree. The cacao tree is generally Theobroma cacao and originates from tropical America and has been cultivated Before Christ. Today, the cacao tree is cultivated not only the tropical America but also other tropical regions such as west Africa, Java, India, Sri Lanka, Indonesia, and like. Cacao raw beans may contain about 2% Theobromine, about 6% tannin, about 0.4% caffeine, and about 50% fat.

General cacao materials may be produced in a various form via a cacao fruit processing. During the processing, the cacao fruit is cut, the cacao raw beans are removed therefrom, and the beans are fermented and dried. Next, the dried beans are peeled to obtain cacao nibs. The cacao nibs are ground to form a cacao mass. The cacao mass is squeezed and hence the cacao butter is extracted. The residue from the squeezing is called as a cacao cake. The cacao cake is milled to form a cacao powder.

At a given point during such a processing, the alkalization is preformed to reduce acidity in the raw cacao beans to improve the fragrance and flavor of the resulting cacao material. Further, using the alkalization, a variety of levels of chromaticity in the resulting cacao material may be achieved.

Conventional alkalization involves reaction of the cacao material with the mixture of the solvent and the alkaline chemical agent including sodium hydroxide, mono potassium phosphate, sodium bicarbonate, or ammonium bicarbonate, etc. The flavor and color of the resultant cacao product may vary via an adjustment of the process parameters such as concentration, reaction time, reaction temperature, reaction pressure, etc of the mixture employed in the processing, based on the type of the cacao raw beans to be processed.

However, such a conventional processing may involve limitation of use amount of the chemical agent in compliance with the food regulations. Further, due to excessive residue of the neutralization agent to neutralize the alkaline chemical agent, the quality of the resultant product may deteriorate otherwise. The concernment of the consumers about using chemical agents that may be harmful to the human body could lead to lower consumption of the cacao product.

### SUMMARY

### Technical Object

The present invention provides a method of treating a cacao material using alkaline electrolyzed water. The present invention aims at providing a method of treating a cacao material using alkaline electrolyzed water generated via an electrolysis of water, compared to the conventional method using the chemical agent, to produce a cacao product free of the chemical agent residue and thus minimizing maleficence to the human body.

Nevertheless, the present invention is not limited to the above objects. Other objects of the present invention may be apparent to the skilled person to the art from reading the following descriptions and appended claims.

### Technical Solution

In one aspect of the present invention, there is provided a cacao material treatment method comprising preparing alkaline electrolyzed water, and reacting the alkaline electrolyzed water with a cacao material.

Further, in one embodiment, the alkaline electrolyzed water may have pH 9 to pH 14.

Further, in one embodiment, the reacting may comprise adding a chemical agent.

Further, in one embodiment, the chemical agent may comprise sodium hydroxide, mono potassium phosphate, sodium bicarbonate, or ammonium bicarbonate.

Further, in one embodiment, the cacao material may comprise cacao nibs, cacao mass, cacao powder or a cacao solid containing a cacao powder.

Further, in one embodiment, the method may further comprise drying the cacao material.

Further, in one embodiment, the method may further comprise roasting the cacao material.

### Technical Effects

In accordance with the present invention, there may be obtained the eco-friendly cacao material free of the chemical agent residue and thus minimizing maleficence to the human body.

Further, the easy control of the reaction time, reaction temperature and reaction pressure as well as neutralizing solution pH used in the neutralization may be achieved via adjustment of the alkaline electrolyzed water pH.

In accordance with the present invention, the higher quality cacao material may be obtained and the production cost thereof may be lowered via enhancement of treatment efficiency thereof.

The effects of the present invention may not be limited to the above effects. Other effects of the present invention may be apparent to the skilled person to the art from reading the following descriptions.

### BRIEF DESCRIPTION OF DRAWINGS

FIG. 1. shows a first flow chart illustrating a cacao material treatment method using alkaline electrolyzed water in according to an embodiment of the present invention.

FIG. 2 shows a second flow chart illustrating a cacao material treatment method using alkaline electrolyzed water in according to an embodiment of the present invention.

### DETAILED DESCRIPTION

The objects, effects and technical solutions therefor of the present invention may be apparent with reference to the following detailed description in conjunction with the accompanying drawings. To illustrate the present invention, well known functions and/or configurations have not been described in detail in order not to unnecessarily obscure the present invention. The term(s) used herein may be defined under consideration of its function, structure and role in the present invention, which may vary depending on intentions of the user or operator or common practices.

The present invention may be not limited to the embodiments disclosed below but rather may be implemented in a variety of another embodiments. The presented embodiments may be provided to make the disclosure of the present invention complete and to enable the skilled person to the art to fully understand the category of the present invention. The present invention may be defined only by the category described in the appended claims. Thus, the definition may be made based on the entirety of the description of the present invention.

As used herein, when an element A “comprises or includes or has” an element B, the element A never excludes another element C but further includes another element C unless specified otherwise.

Hereinafter, a cacao material treatment method using alkaline electrolyzed water in according to the present invention will be set forth in details with reference to the accompanying drawings.

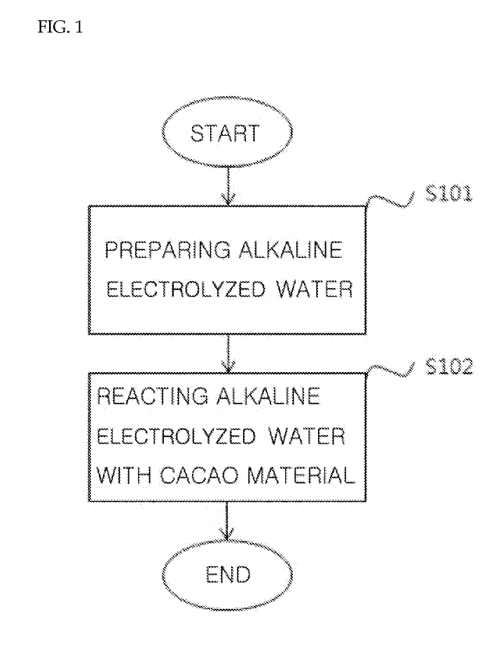

FIG. 1 shows a first flow chart illustrating a cacao material treatment method using alkaline electrolyzed water in according to an embodiment of the present invention.

The cacao material treatment method using alkaline electrolyzed water in according to an embodiment of the present invention, as shown in FIG. 1, may include preparing alkaline electrolyzed water (S101); and reacting the alkaline electrolyzed water with a cacao material (S102).

The preparing of the alkaline electrolyzed water (S101) according to an embodiment of the present invention may employ the alkaline electrolyzed water equal to or higher than pH 7. More preferably, the alkaline electrolyzed water may have pH 9 to pH 14 to exhibit a strong reducing power. The alkaline electrolyzed water having such a pH range may effectively reduce the acid substance in the cacao raw bean to render the same sour or bitter, or serve to sterilize or do anti-bacterial function to prevent corruption or bacterial infection or to maintain freshness.

The alkaline electrolyzed water may eliminate excessive free radicals on the human body or food. The alkaline electrolyzed water may enhance the flavor or color of the food material. The alkaline electrolyzed water may remain as water in the food material after the processing thereof. Thus, the alkaline electrolyzed water may be useful to improve the quality of the cacao material.

The alkaline electrolyzed water may be generated using the electrolysis bath having opposite positive and negative electrodes. While edible water is received in the bath, the power is applied across the positive and negative electrodes such that the alkaline electrolyzed water is collected from the negative electrode. Where there is an ionic partition wall between the positive and negative electrodes, the hydrogen gas is generated at the negative electrode side, and the hydroxyl ions are confined by the ionic partition wall, to generate the alkaline electrolyzed water. On the other hand, at the positive electrode side, the oxygen gas is generated and hydrogen ions are confined by the ionic partition wall, to generate the acidic electrolyzed water. The mineral elements contained in the water prior to the electrolysis may remain in an active ionic state in the electrolyzed water. The mineral elements may be contained in the cacao material during the reaction between the cacao material and the alkaline electrolyzed water.

When an electrolyte such as sodium chloride is added to the water to be electrolyzed, more strong alkaline electrolyzed water may be easily generated.

The reaction of the alkaline electrolyzed water with the cacao material (S102) according to an embodiment of the present invention may include adding the conventional chemical agents. The chemical agent may comprise, for example, sodium hydroxide, mono potassium phosphate, sodium bicarbonate, or ammonium bicarbonate, etc.

The sodium hydroxide exhibits a strong alkalinity in the water solution state and is usedas an alkaline agent or neutralization agent for producing food. The mono potassium phosphate exhibits a strong alkalinity in the water solution state and is used as a seasoning additive, swelling agent, or meat binding agent in food-producing process. The sodium bicarbonate exhibits a strong alkalinity in the water solution state and is used as a compounding agent or swelling agent in the producing food. The ammonium bicarbonate exhibits a strong alkalinity in the water solution state and is used as a fermentation-accelerating agent, compounding agent or swelling agent in the producing food. The chemical agents have been employed as the conventional alkalization agent to treat the cacao material. Thus, the chemical agents should be removed or neutralized from the resultant cacao product. Unlike the conventional alkalization approach, in one embodiment, the trace amount of chemical agents may be added to the electrolyzed water to support the primary alkalization with the alkaline electrolyzed water. The trace amount of the chemical agents may be adjusted not to remain in the resulting product.

The cacao material may have a variety of forms depending on a specific point during the processing thereof in accordance with an embodiment of the present invention. The followings may set forth the specific forms of the cacao materials at a given point during the processing.

First, the cacao raw beans may be selected and dried using a natural wind or wind-generation device and then may be cleaned to remove the foreign substance. Such cleaned beans may be broken into pieces using the crusher and winnowed to form “cacao nibs”.

Next, the cacao nibs may be milled using a lower pressure to form “a cacao mass” in a liquid state. Then, the cacao mass may be separated, using an oil-extraction device, into “a cacao butter” in an oil state and “a cacao cake” in a substantially solid state.

Next, the cacao cake may be formed, using a roller or milling device, into the powder to form “a cacao powder”.

Thus, the cacao material as used herein may include the cacao nibs, cacao mass, cacao butter, cacao cake, and cacao powder. However, the cacao material is not limited thereto. The cacao material may include another forms derived from the cacao raw beans.

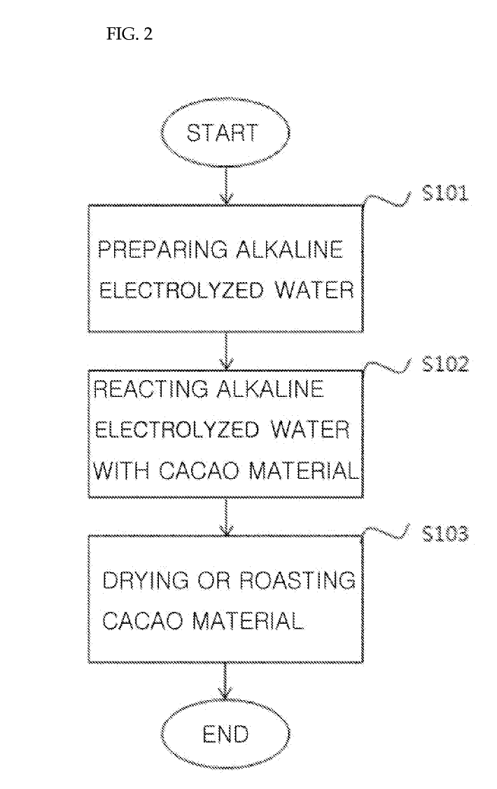

FIG. 2 shows a second flow chart illustrating a cacao material treatment method using alkaline electrolyzed water in according to an embodiment of the present invention.

In accordance with an embodiment, the desired forms of the cacao material may be selected and be alkalized among the variety of forms thereof by the skilled person to the art based on its usage. In one embodiment, a drying and/or roasting step (S103) may be further carried out, prior to the reaction between the alkaline electrolyzed water and the cacao material (S102), to improve the flavor and color of the cacao material.

The drying and/or roasting step may aim at removing moisture to prevent the bacteria propagation. Further, the drying and/ or roasting step may aims at improving the flavor and color of the cacao material. The drying method may include a conventional drying method such as a low temperature drying, evaporation drying, or vacuum drying. The roasting method may employ a direct heating type or batch type with setting of the heating temperature and time.

Alternatively, the drying and/or roasting step (S103) may be further carried out after the reaction between the alkaline electrolyzed water and the cacao material (S102). This drying and/or roasting step may aim at removing a signification portion, while leaving an appropriate amount, of the moisture added into the cacao material during the alkalization process, to prevent the microorganism propagation. Further, the drying and/or roasting step may aims at improving the flavor, fragrance and color of the cacao material.

Although the step (S102) is shown to occur prior to the step (S103) in FIG. 2 for the sake of convenience, the present invention is not limited thereto. As mentioned above, the drying and/or roasting step (S103) may be carried out after and/or before the reaction between the alkaline electrolyzed water and the cacao material (S102).

The cacao products containing the cacao materials treated using the embodiments of the present invention are not limited in an application thereof. For example, the cacao products may include a chocolate product such as a milk chocolate product, a dark chocolate product, a chocolate perfume product, a chocolate snack, a chocolate-fragrant snack, a chocolate drink, a chocolate-fragrant drink, a chocolate dairy product, a chocolate-fragrant dairy product, a chocolate food supplement, a chocolate-fragrant food supplement, a chocolate-coating product, a low-fat chocolate product, a low-sugar chocolate product, or no-sugar chocolate product.

Now, the present invention will be described in more specific manner in accordance to an example. The present invention may not be limited thereto.

The properties of the cacao material treated using the alkaline electrolyzed water may be analyzed in pH variation and chromaticity variation thereof using the example.

Analysis of the pH property of the cacao material treated using the alkaline electrolyzed water may indicate the alkalinity of the cacao material. The pH property may be measured using the Mettler Toledo MP220 pH meter.

Analysis of the chromaticity property of the cacao material treated using the alkaline electrolyzed water may be used to find out variations of the color of the cacao material. The chromaticity may be measured using Chroma Meter CR-400 from Konica Minolta. Measurements have been carried out 8 times. The average of the measurements has been found. The measurement factor may include a brightness L, a red-rendering tendency a, and a yellow-rendering tendency b. As the L, a and/or b values are smaller, the chromaticity may be darker.

### EXAMPLE 1

(a) The cacao nibs are ground and are filtered using a mesh 1 mm sieve to obtain cacao nibs particles with a uniform size. The cacao nibs particles are prepared by 50 g.
(b) The alkaline electrolyzed water with pH 11.5 by 50 g is prepared by adding small amount of NaCl into tap water and performing electrolysis thereof using the strong electrolyzed water generator BTM-3000 commonly available from Biontech Co., Ltd in South Korea.
(c) The cacao nibs particles 50 g and the alkaline electrolyzed water 50 g are mixed with each other and stirred for one minute and react with each other for 20 minutes.
(d) The reaction product is filtered using a paper filter to remove the moisture therefrom. The removed moisture is maintained at 15 ° C. and then is measured in pH thereof.
(e) The solid remained by filtering the moisture, is dried using a drying oven at 70° C. for 3 hours.
(f) The dried solid is milled and is injected into a Petri dish and is compressed. The compressed solid is measured in chromaticity thereof.

### Comparison Example 1

(a) The cacao nibs are ground and are filtered using a mesh 1 mm sieve to obtain cacao nibs particles with a uniform size. The cacao nibs particles are prepared by 50 g.
(b) The tap water with pH 8.02 is prepared by 50 g.
(c) The cacao nibs particles 50 g and the tap water 50 g are mixed with each other and stirred for one minute and react with each other for 20 minutes.
(d) The reaction product is filtered using a paper filter to remove the moisture therefrom. The removed moisture is maintained at 15° C. and then is measured in pH thereof.
(e) The solid remained by filtering the moisture, is dried using a drying oven at 70° C. for 3 hours.
(f) The dried solid is milled and is injected into a Petri dish and is compressed. The compressed solid is measured in chromaticity thereof.

### Comparison Example 2

(a) The cacao nibs are ground and are filtered using a mesh 1 mm sieve to obtain cacao nibs particles with a uniform size. The cacao nibs particles are injected into a Petri dish and are compressed. The compressed particles are measured in chromaticity thereof.

The following table 1 shows comparison in pH between the example 1 and the comparison example 1:

TABLE 1

| | pH |
|---|---|
| Example 1 | 5.92 |
| Comparison example 1 | 5.17 |

As shown in the above table 1, the case using the alkaline electrolyzed water (example 1) indicates higher pH property than the case using the general tap water (comparison example1). That is, as the pH value is higher, the alkalinity is greater. In this manner, using the alkaline electrolyzed water, the cacao material may be more effectively alkalized.

In addition, when the pH value of the alkaline electrolyzed water become higher than in the example 1 and/or the reaction temperature and/or pressure is applied and/or the reaction time is controlled, the cacao material with much greater alkalinity may be produced. Further, when the strong alkaline chemical agent is added by small amount during the alkalization step, the reduction power is further greater to enhance the alkalization.

The following table 2 shows comparisons in chromaticity between the example 1 (below, “ex 1”) and the comparison examples 1 and 2 (below, “cp ex 1” and “cp ex 2” respectively):

TABLE 2

| | | 1 | 2 | 3 | 4 | 5 | 6 | 7 | 8 | mean |
|---|---|---|---|---|---|---|---|---|---|---|
| Ex | L | 37.01 | 37.13 | 37.19 | 37.21 | 37.20 | 37.22 | 36.34 | 36.35 | 36.98 |
| 1 | a | 8.33 | 8.38 | 8.44 | 8.38 | 8.44 | 8.40 | 8.33 | 8.34 | 8.38 |
| | b | 12.96 | 13.05 | 13.01 | 13.06 | 13.04 | 13.06 | 12.92 | 12.91 | 13.00 |
| Cp | L | 38.58 | 38.65 | 38.70 | 38.71 | 38.72 | 38.73 | 38.43 | 38.44 | 38.63 |
| ex | a | 8.79 | 8.87 | 8.88 | 8.83 | 8.87 | 8.84 | 8.83 | 8.92 | 8.85 |
| 1 | b | 13.62 | 13.61 | 13.62 | 13.67 | 13.67 | 13.67 | 13.59 | 13.66 | 13.64 |
| Cp | L | 40.75 | 40.89 | 39.64 | 40.75 | 41.50 | 41.28 | 40.43 | 40.63 | 40.74 |
| ex | a | 14.73 | 14.82 | 14.61 | 14.67 | 14.42 | 14.37 | 14.34 | 14.34 | 14.54 |
| 2 | b | 20.77 | 20.91 | 20.18 | 20.75 | 20.17 | 20.10 | 19.71 | 19.93 | 20.33 |

As shown in the above table 2, the case using the alkaline electrolyzed water (ex 1) indicates greater chromaticity variation from the case without the alkalization and drying steps (cp ex 2) than the case using the tap water (cp ex 1). That is, the L, a and b values have a larger variation from cp ex 2 in the ex 1 than in the cp ex 1. As the values L, a and/or b are smaller, the chromaticity is darker. The case using the alkaline electrolyzed water (ex 1) shows the lowest values of L, a and/or b and thus exhibits the darkest chromaticity.

In addition, when the pH value of the alkaline electrolyzed water become higher than in the example 1 and/or the reaction temperature and/or pressure is applied and/or the reaction time is controlled, the cacao material with much darker chromaticity may be produced. Further, when the strong alkaline chemical agent is added by small amount during the alkalization step, the reduction power is further greater to enhance the alkalization.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A cacao material treatment method comprising:
preparing alkaline electrolyzed water; and
reacting the alkaline electrolyzed water with a cacao material.

2. The method of claim 1, wherein the alkaline electrolyzed water has PH 9 to PH 14.

3. The method of claim 1, wherein the reacting comprises adding a chemical agent.

4. The method of claim 3, wherein the chemical agent comprises sodium hydroxide, mono potassium phosphate, sodium bicarbonate, or ammonium bicarbonate.

5. The method of claim 1, wherein the cacao material comprises a cacao nib, cacao mass, cacao powder or a cacao solid containing a cacao powder.

6. The method of claim 1, further comprising drying the cacao material.

7. The method of claim 1, further comprising roasting the cacao material.

8. A cacao product containing the cacao material treated via the method of claim 1.

9. The method of claim 6, further comprising roasting the cacao material.
